(19) United States
(12) Patent Application Publication
(10) Pub. No.: US 2013/0240473 A1
(43) Pub. Date: Sep. 19, 2013

(54) UNIFORM TENSION DISTRIBUTION MECHANISM FOR STRETCHED MEMBRANE SOLAR COLLECTORS

(71) Applicants: Howard Harrenstien, Miami, FL (US); Taber Smith, Saratoga, CA (US); Stephen Diaz, Palo Alto, CA (US)

(72) Inventors: Howard Harrenstien, Miami, FL (US); Taber Smith, Saratoga, CA (US); Stephen Diaz, Palo Alto, CA (US)

(21) Appl. No.: 13/422,925

(22) Filed: Mar. 16, 2012

(51) Int. Cl. F16M 13/00

(52) U.S. Cl. 211/183

(57) ABSTRACT

An improved end form for flexible membrane solar collectors including a whiffle-tree attached near the peripheral edge of the end form. The end form is “C” shaped with the curve of the upper edge the same as the peripheral edge so as to simplify manufacture.

### BACKGROUND OF THE INVENTION

The invention relates to an improved design for a key component of linear tensioned membrane reflectors for solar parabolic trough concentrators, solar linear reflectors, and linear heliostats for solar Fresnel reflecting systems, specifically, those that utilize thin flexible films for the membrane substrate.

A thin membrane of highly reflecting material, such as metalized reflective plastic film, is securely attached at the peripheral edges of parallel-facing end form members for uniformly tensioning and stretching the membranes into long, semi-rigid and accurately formed trough surfaces that create the critical focusing mirror component of the collector. Each end form member has a cross-sectional curved shape selected to produce the desired cross-sectional shape, usually parabolic, of the reflector. The end forms, which control the accuracy of the curved membrane surface, are manufactured to very close tolerances to last the life of the product. The membrane is then placed under 1000 to 7000 pounds per square inch (PSI) of tension in the longitudinal direction, usually by carefully moving one of the end form members away from the other.

Linear tensioned membrane reflectors have many advantages over more traditional designs incorporating rigid frame structures. They are generally less expensive, relatively light weight, and easy to assemble and replace. Because of their light weight, and corresponding ability to be stretched over long spans, the membranes are able to be firmly attached at the ends of their spans to simple light weight frame structures which are capable of being easily rotated about their longitudinal axis to precisely track the sun as it moves across the sky. This in turn produces a very efficient and economical method for solar energy conversion using a minimum of tracking force.

However, linear tensioned membrane reflector technology presents certain problems that do not exist for linear solar reflector technologies constructed with a rigid reflector structure. A single die spring centered on the end form and attached to the outer supporting frame can provide the tensile force sufficient to place the entire membrane of the reflector in a state of longitudinal tension. But, variations in longitudinal tension may produce wrinkles and other shape distortions that reduce the effectiveness of the collector.

Thus, while is desirable to reduce the weight of the end form in order to reduce the weight of the collector, before the improvements of this current invention, end forms have generally been “D” shaped and either solid or ribbed and have been constructed of die or sand cast aluminum, a complicated and expensive manufacturing process. Moreover, even with standard “D” shaped end forms, careful measurements have shown that slight bending of the end forms can still occur which can produce undesirable variations in longitudinal tension in the resulting stretched membrane. Generally, these variations would be overcome by increasing the thickness of the end form at the cost of increasing the weight of the collector.

It is an objective of this invention to reduce the wrinkles and other shape distortions that may occur when thin films are used as a membrane substrate in tensioned membrane solar reflectors, thus producing undistorted reflective surfaces which precisely focus solar energy reflections on the longitudinal collector receiving pipe.

It is a further objective of this invention to reduce the materials used to create the end forms.

It is a further objective of this invention to simplify the manufacturing process for the end forms.

### BRIEF SUMMARY OF THE INVENTION

The present invention teaches that by using a single or double whiffle-tree mechanism (also referred to as a whiffle-tree) to distribute the tensile force uniformly along the peripheral edge of the end form, the bending of the end form, and thus the possible distortion of the membrane, can be significantly reduced, for practical purposes, or eliminated. Further, the uniform distribution of the overall tensile force reduces the load transfer stresses sufficiently to allow for a “C” shaped end form to be developed which uses significantly less material than the solid or ribbed design, while delivering better and more reliable performance. Finally, this design allows for the same shape to be used in cutting the peripheral edge of the end form and the upper edge of the end form, simplifying the manufacturing process.

### BRIEF DESCRIPTION OF THE DRAWINGS

FIG. 1 shows a ribbed end form as taught by in the prior art.

FIG. 2 shows the “C” shaped curved member of the present invention.

FIG. 3 shows an embodiment of the present invention including an eight-point, single-pull whiffle-tree.

FIG. 4 shows a second embodiment of the present invention including a sixteen-point, single-pull whiffle-tree.

FIG. 5 shows a perspective view of the embodiment of FIG. 3.

FIG. 6 shows a perspective view of the embodiment of FIG. 4

FIG. 7 shows an embodiment of the present invention including an eight-point, dual-pull whiffle-tree.

FIG. 8 shows a second embodiment of the present invention including a sixteen-point, dual-pull whiffle-tree.

FIG. 9 shows a perspective view of the embodiment of FIG. 7

FIG. 10 shows a perspective view of the embodiment of FIG. 8.

FIG. 11 shows an alternative embodiment of the present invention.

FIG. 12 shows a first alternative bar shape for use in the present invention.

FIG. 13 shows a second alternative bar shape for use in the present invention.

FIG. 14 shows a third alternative bar shape for use in the present invention.

FIG. 15 shows a fourth alternative bar shape for use in the present invention.

FIG. 16 shows a perspective view of the embodiment of FIG. 7 in use in a solar collector.

### DETAILED DESCRIPTION OF THE INVENTION

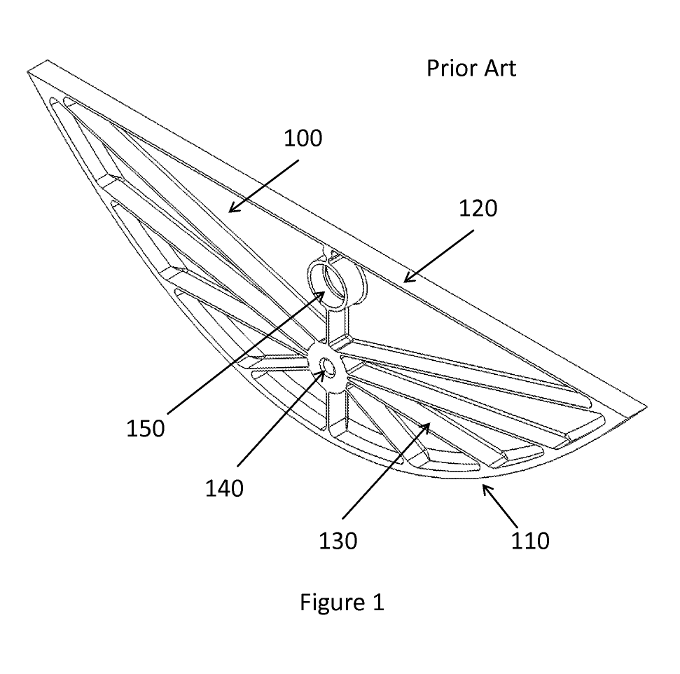

FIG. 1 shows the “D” shaped, ribbed end form 100 of the prior art. The ribbed end form 100 includes a peripheral edge 110 which holds the flexible reflective membrane of the collector into the appropriate, usually parabolic, shape, but also includes a cross-piece 120. A plurality of ribs 130 extend from points near the center of the “D” form toward the peripheral edge 110 and the cross-piece 120. Tensile force, which can be effected through a die spring (not shown), can be applied to the ribbed end form 100 at a point 140 near the center of the form. The ribbed end form 100 is also adapted to receive a single die spring or similar device for applying tensile force or holding the end plate in place on a support frame, thus allowing two parallel plates to appropriately stretch and shape the flexible reflective membrane. A second opening 150, is positioned in the ribbed end form 100 at an appropriate location, generally the focal point of the parabola, and is adapted to accept a pipe or similar device carrying liquid to be heated or a material that can otherwise utilize the concentrated solar energy collected.

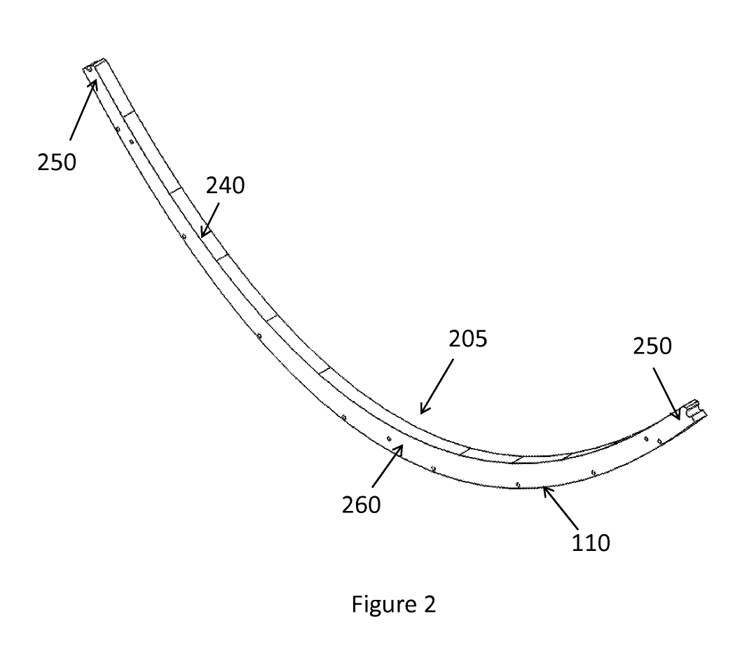

With reference to FIGS. 2 through 10, the end form of the present invention includes a curved member 205 that forms the peripheral edge 110. Generally, the peripheral edge 110 will be designed so as to cause the reflective membrane of the solar collector to form a parabolic cross-section when the end form is in use. The curved member 205 also has an upper edge 240. Preferably, for ease of manufacture, the curve of the upper edge 240 is identical to the curve of the peripheral edge 110 in that the same curved shape is used to cut both edges. The curved member is preferably cut from 1 inch thick aluminum and ranges from approximately 2 inches wide at the upper points 250 of the curved member 205 to approximately 3 inches wide at the bottom 260 of the curved member 205. It will be understood that the exact measurements could vary depending on other design factors, including the amount of force to be applied to the end form, the physical properties of the material from which the curved member is created, and the thickness of that material. However, as will be evident to those of ordinary skill in the art, use of the same curve to create the upper edge 240 and peripheral edge 110 will result in the upper points 250 of the curved member 205 to be narrower than the bottom 260 of the curved member 205. It should also be noted that while there are significant advantages to using a narrow curved member with similar upper and lower curve shapes, the curved member could be wider, and even retain a “D” shape, and still obtain advantages by using the features described below.

The end form of the current invention also includes a whiffle-tree, which is sometimes also known as a whiffle-tree. A whiffle-tree consists of a bar with a pivot or similar connector point, usually located at or near the center of the bar, with a normal force applied from one direction at the pivot. The force is divided or “split” by the mechanism and transmitted to the ends of the bar proportionally to the distances of the ends to the pivot point. Whiffle-trees may be used in series to distribute the force further. Placement of the pivot at a location other than at, or very near, the center of the bar, for example at a point one-third the length of the bar from one end, may be appropriate in certain unusual applications depending on the geometry of the end form.

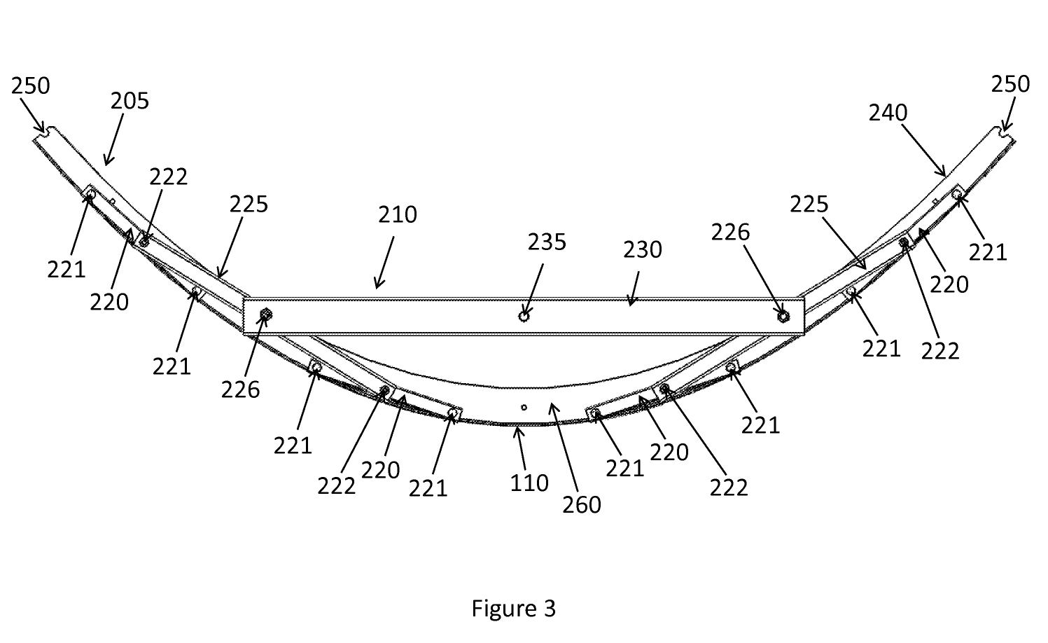

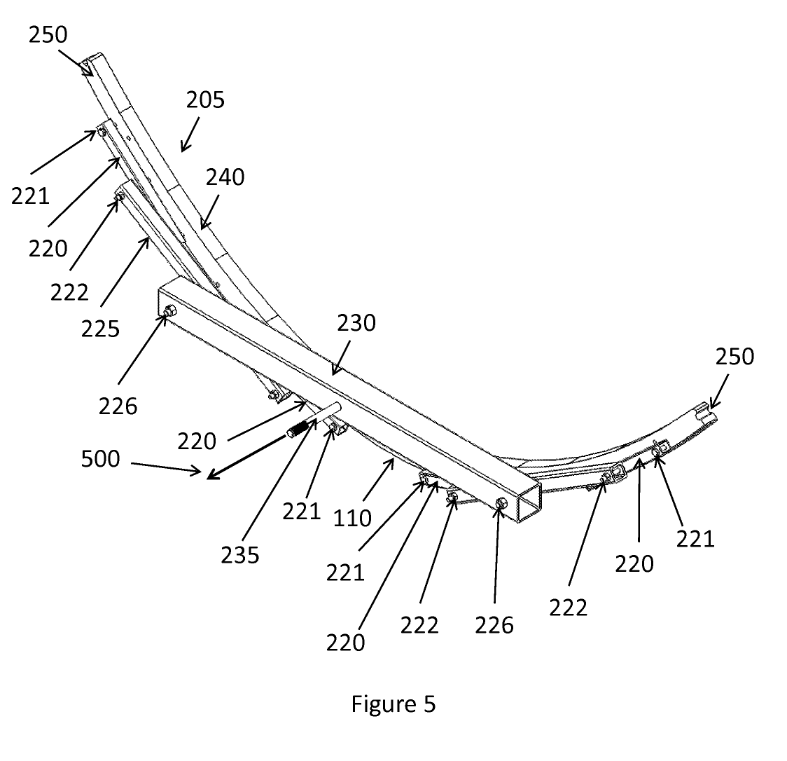

With reference to FIGS. 3 and 5, the embodiment of the improved end form shown employs an 8-point whiffle-tree 210 consisting of seven bars at different “levels” away from the curved member. Each end of four fixed bar members 220 is attached near the peripheral edge 110 of the curved member 205 with eight fixed attachment points 221, which are preferably equally and symmetrically spaced at set intervals along the curve of the peripheral edge 110 or otherwise to distribute the tensile force evenly. Thus, the distance between the ends of each of the fixed bar members 220 is close, although slightly shorter, to the overall length of the fixed bar members 220 themselves.

A first pivot 222 is positioned near the center of each of the fixed bar members 220. The first pivots 222 are attached to the ends of the two second level bar members 225, each of which has a second pivot 226 near the center of the member. A top bar member 230 is attached at each end to the second pivots 226. Tensile force 500 is applied at the center 235 of the top bar member 230 in order to allow the end form stretch and shape the flexible membrane of the solar collector.

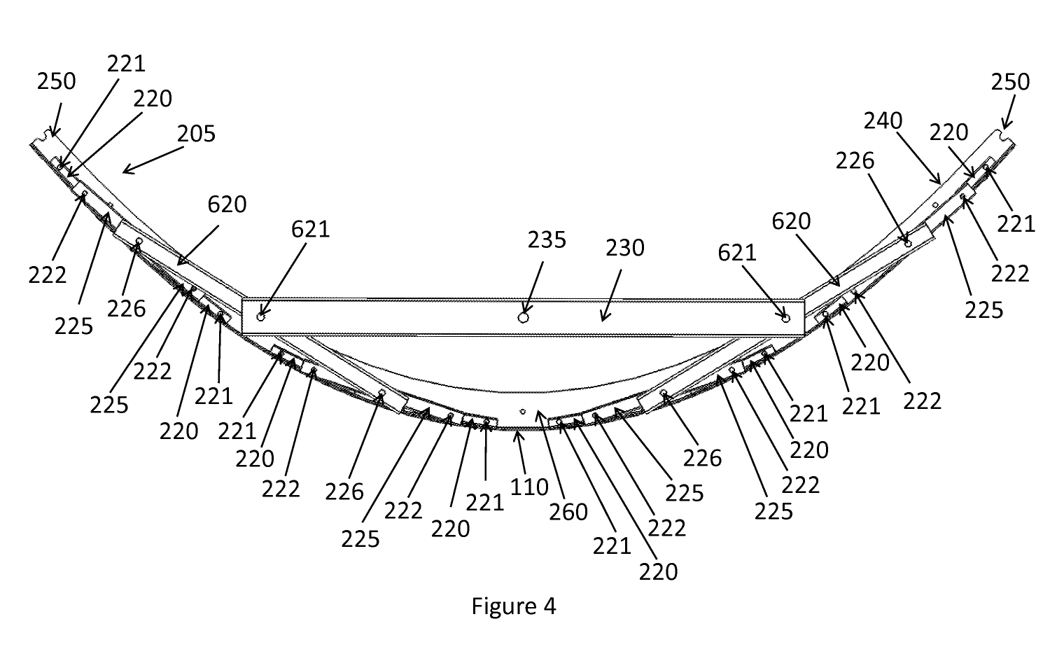

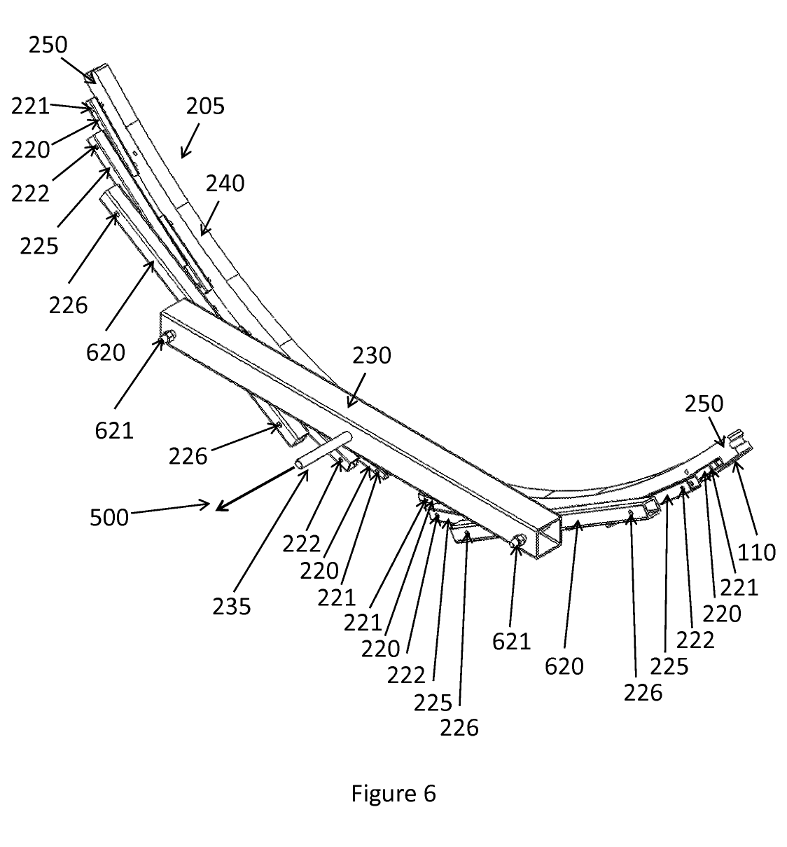

With reference to FIGS. 4 and 6, the embodiment of the end form shown incorporates a sixteen point whiffle-tree, attached to the curved member 205 in a manner similar to that described with respect to FIGS. 3 and 5. In this embodiment, there are eight fixed bar members 220 attached directly to the curved member 205, and the ends of the fixed bar members 220 fixedly attached at sixteen fixed attachment points 221 to the curved member 205. In addition to four second level bar members 225, the ends of which are attached to the first pivots 222 in the approximate center of the fixed bar members 220, there are additionally two third level bar members 620 with central pivot points 621 to which the top bar member 230 is attached. As with the 8-point whiffle-tree, a single tensile force 500 is applied at or near the center 235 of the top bar member 230, but is distributed to sixteen rather than eight points near the peripheral edge 110 of the curved member 205.

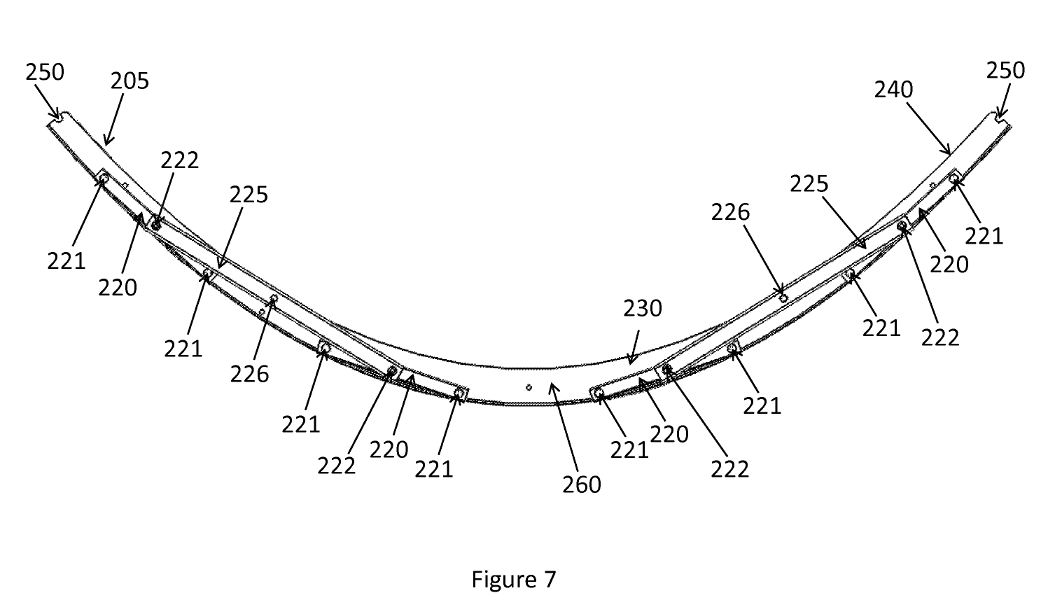

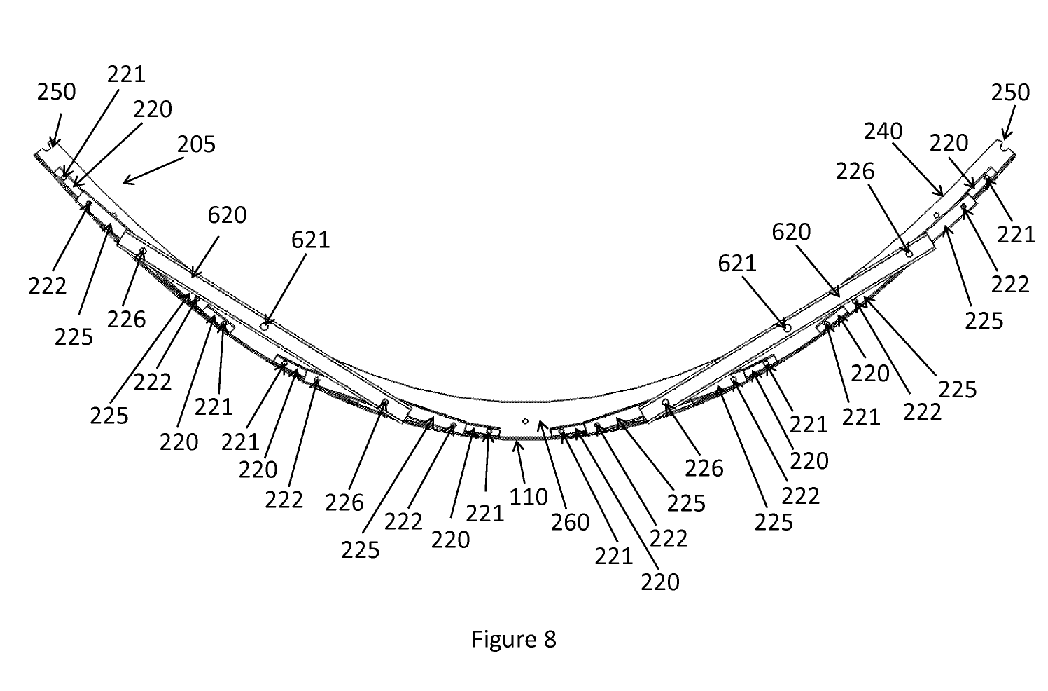

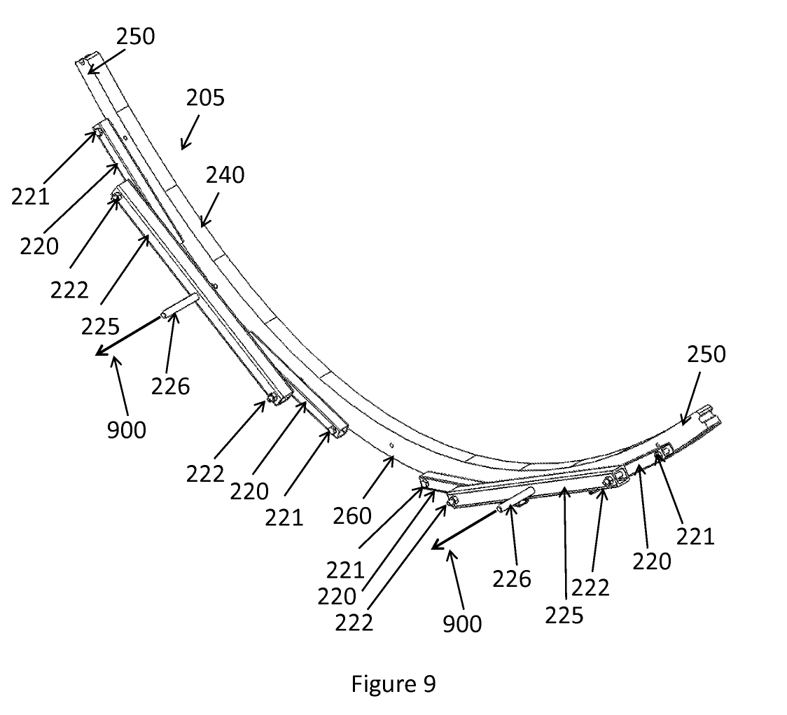

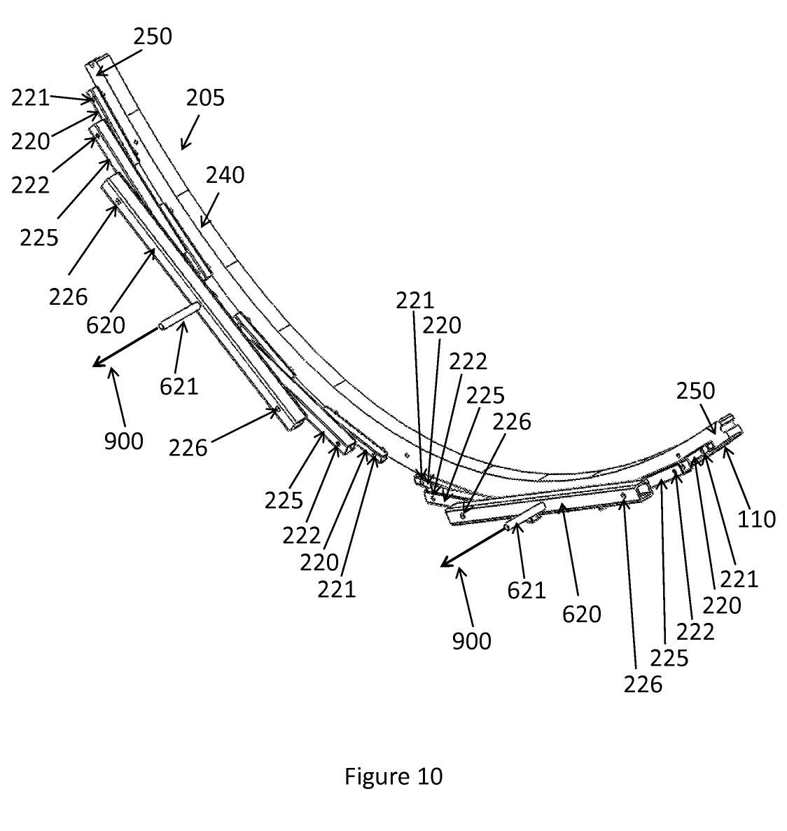

With reference to FIGS. 7 through 10, it is possible to eliminate the single top bar member 230 of the whiffle-tree, and, instead have two substantially equal tensile forces applied at each second pivot 226. Essentially, then, as shown in FIGS. 7 and 9, two 4-point whiffle-trees are positioned symmetrically on the curved member 205 to form an 8-point dual pull whiffle-tree and in FIGS. 8 and 10 two 8-point whiffle-trees are positioned symmetrically on curved member 205 to form a 16-point dual pull whiffle-tree. The tensile force 900 is applied at the second pivots 226 for the 8-point dual pull whiffle-tree and at the central pivot points 621 of the third level bar members 620 for the 16-point dual pull whiffle-tree. The “two-pull” approach uses fewer components, and thus may be less expensive to construct. Further, the two-pull design may use less longitudinal space in the solar collector frame, since there fewer levels of bars that need to be accommodated, thus increasing the area of the reflector available to collect sunlight. Finally, when a single tensile force 500 is applied at a single top bar member 230, the end form has a tendency to rotate about the point 235, which may necessitate the use of an additional device attached to the frame of the solar collector to prevent undue rotation. The two-pull approach eliminates the need to have an additional device to prevent internal rotation. However, the two-pull approach does require, for most applications, that the tensile force of each pull point be equal. This may be difficult given variations in the frame or other structure from which the force is applied to the pulls. For example, beams may be bowed. Mechanical springs, such as die-springs, may be used to ameliorate this problem.

It is preferable that the first bar members 220, although fixedly attached to the peripheral edge 110, not be fastened too tightly to the curved member 205 to allow for slight play or movement and to eliminate torqueing. Thus, if the first bar members 220 are bolted to the curved member 205, the holes (not shown) in the curved member 205 are preferably slightly oversized and the bolts (not shown) would preferably not be fully tightened with a gap between each bolt and the surface of the curved member 205 on the order of ⅛ inch. Locknut, or double nuts, may be used on loose bolts.

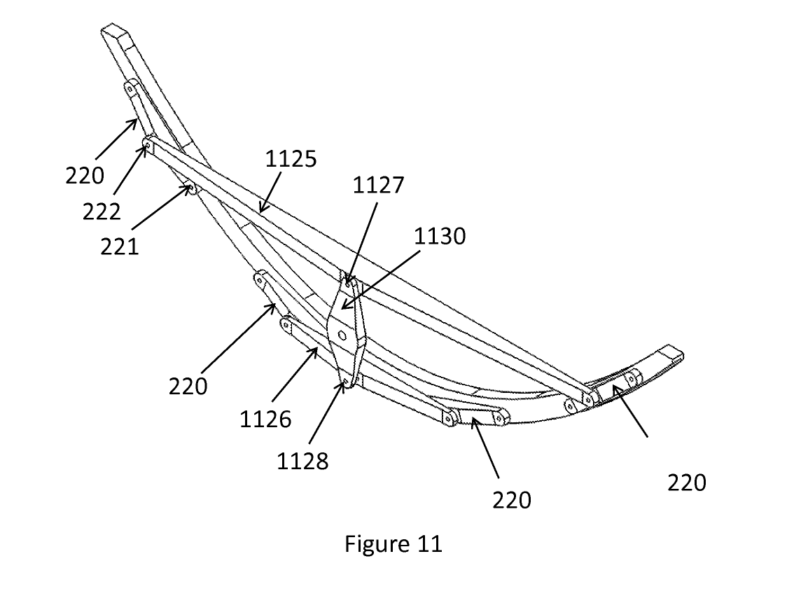

Although the embodiments of FIGS. 3 through 10 show the ends of each second level bar members 225 having approximately the same length and connected to adjacent fixed bar members 220 distributed at approximately equal intervals along the peripheral edge 110, other connection schemes are possible. For example, as shown in FIG. 11, additional bar members 1125 and 1126, performing the same function as the second bar members of FIGS. 2 through 9, may be of different lengths and pivotally connected to first bar members 220 on opposite sides of the curved member 205. The additional bar members 1125 and 1126 are additionally pivotally connected at their centers in a substantially perpendicular arrangement at the mid-points 1127 and 1128 to a final bar member 1130, which is ultimately attached to a source of tensile force and performs the same function as the top bar member 230 shown in FIGS. 3 through 7.

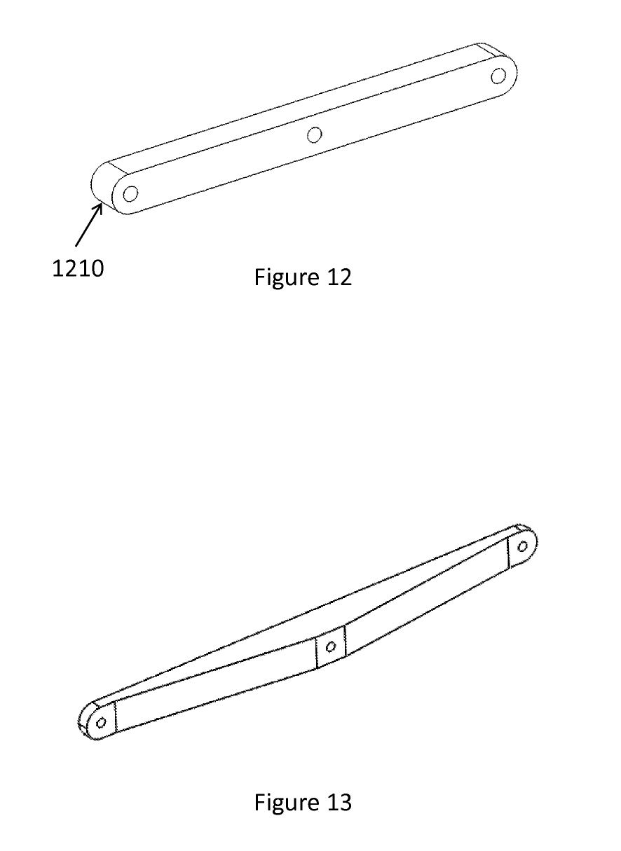

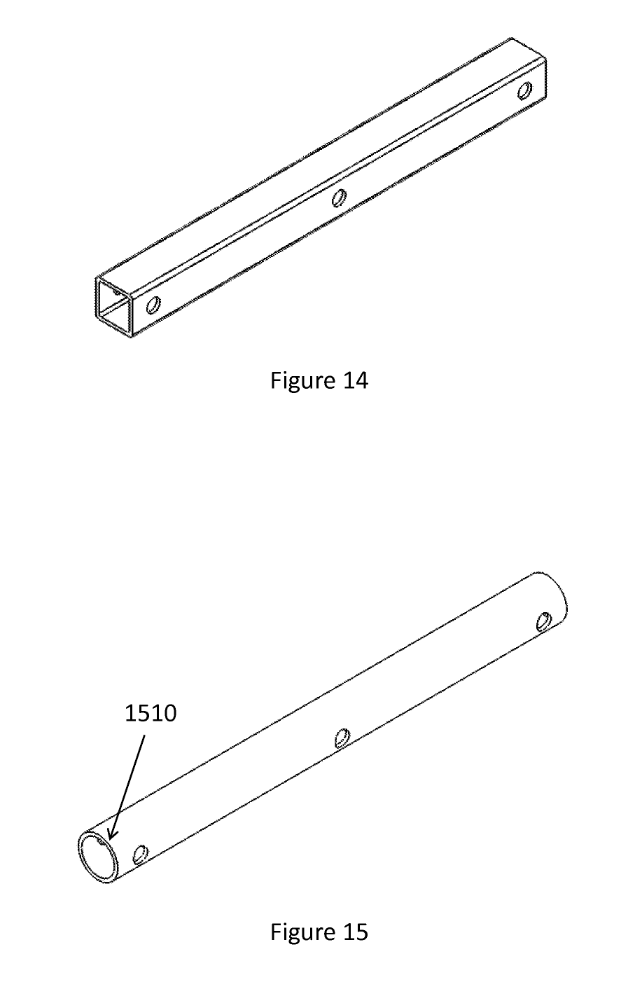

The bars may be of different geometries. In addition to bars having a square or rectangular cross-section with or without rounded ends 1210, as shown in FIGS. 2 through 10 and in FIGS. 12 and 14, bars or rods with circular cross-sections 1510 as shown in FIG. 15 could be used, either as solid bars or hollow bars. Triangular or diamond shaped bars, which may also have varying thickness, as shown in FIGS. 11 and 13 could also be employed and may have advantages in some configurations.

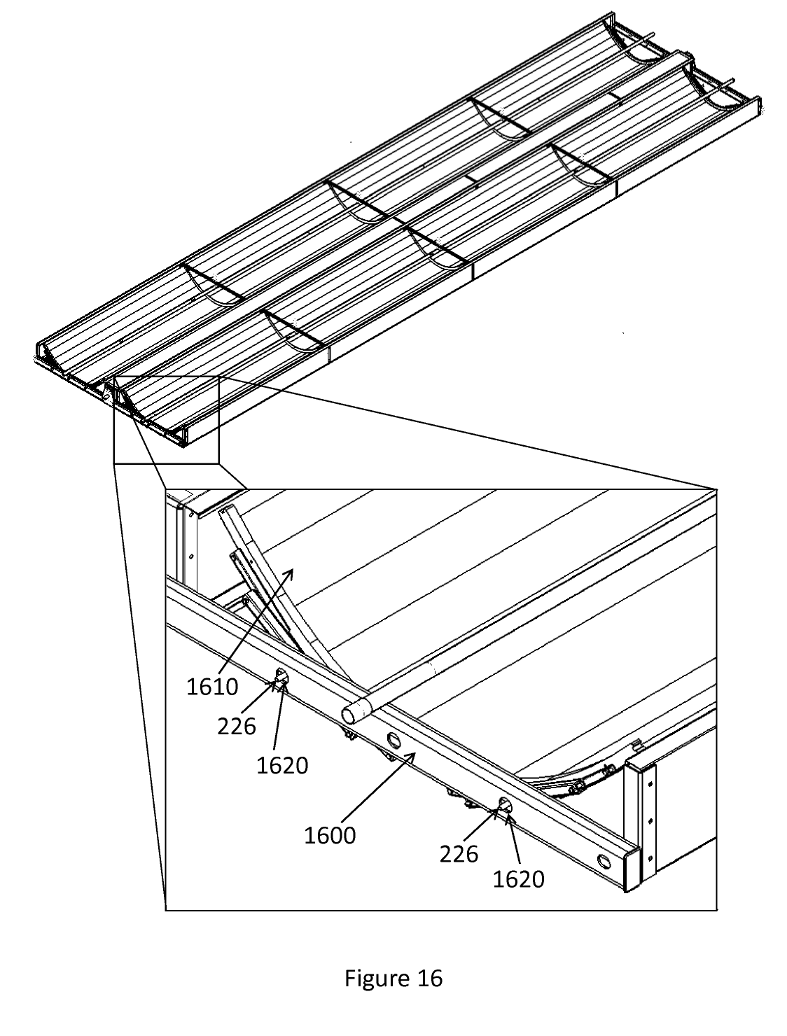

With reference to FIG. 16, an end form of the current invention is shown in use in a solar collector. The 8-point dual pull whiffle-tree embodiment of FIGS. 7 and 9 is shown held in the frame 1600 and stretching the thin film reflective membrane 1610. Holes 1620 in the frame 1600 allow for a source of tensile force to be applied to the second pivots 226.

While the present invention has been shown and described with reference to the foregoing preferred embodiments, it will be apparent to those skilled in the art that changes in form, connection, and detail may be made therein without departing from the spirit and scope of the invention as defined in the appended claims.

We claim:

1. An end form adapted for use in a solar reflector comprising a flexible membrane, the end form comprising:
a curved member defining a peripheral edge adapted to shape the flexible membrane and an upper edge;
a whiffle-tree comprising a plurality of first bar members, each first bar member defining a first end and a second end, and wherein each said first end and second end of the first bar members is fixedly attached to the curved member near the peripheral edge.

2. The end form of claim 1, wherein the whiffle-tree comprises at least eight first bar members.

3. The end form of claim 2, wherein the whiffle-tree comprises at least sixteen first bar members.

4. The end form of claim 1, wherein the peripheral edge defines a selected shape and the upper edge defines substantially the same shape as the peripheral edge.

5. The end form of claim 1, wherein the whiffle-tree comprises at least one second bar member defining two ends, and wherein each end of the second bar member is pivotally attached a first bar member.

6. The end form of claim 5, wherein the whiffle-tree comprises at least four first bar members and at least two second bar members, each said second bar member defining two ends, and wherein each end of each second bar member is pivotally attached to a first bar member.

7. The end form of claim 6, wherein each second bar member includes a connection point near the center of the second bar member, said connection point adapted to connect to a source of tensile force.

8. The end form of claim 7, further comprising a third bar member defining a first end and a second end, and wherein the first end is pivotally attached the connection point of a first selected second bar member and the second end is pivotally attached to the connection point of a second selected second bar member, and wherein the third bar member includes a connection point near the center of the third bar member, said connection point adapted to connect to a source of tensile force.
